(19) United States
(12) Patent Application Publication
(10) Pub. No.: US 2026/0242642 A1
(43) Pub. Date: Aug. 20, 2026

(54) WATER-BASED BONDING ADHESIVE FOR PVC AND KEE ROOFING MEMBRANES

(71) Applicant: CARLISLE CONSTRUCTION MATERIALS, LLC, Carlisle, PA (US)

(72) Inventors: Karan BANSAL, Carlisle, PA (US); Michael Scanish, Camp Hill, PA (US)

(73) Assignee: CARLISLE CONSTRUCTION MATERIALS, LLC, Carlisle, PA (US)

(21) Appl. No.: 19/542,413

(22) Filed: Feb. 17, 2026

Related U.S. Application Data
(60) Provisional application No. 63/760,908, filed on Feb. 20, 2025.

(51) Int. Cl. C09J 113/02; C09J 119/02

(52) U.S. Cl. CPC C09J 113/02; C09J 119/02

(57) ABSTRACT

A water-based adhesive for PVC and KEE roofing membranes, including: (a) a first latex made from: (i) vinyl acetate, (ii) ethylene, and (iii) butyl acrylate or ethyl acrylate monomers, wherein the first latex has a glass transition temperature between −25 to −45 C; (b) a second latex made from: (i) vinyl acetate, and (ii) ethylene monomers, wherein the second latex has a glass transition temperature between −10 C to 5 C; and (c) a polyurethane dispersion (PUD).

### RELATED APPLICATION

The present application claims priority to U.S. Provisional Patent Application Ser. No. 63/760,908, of same title, filed Feb. 20, 2025, the entire disclosure of which is incorporated herein by reference in its entirety for all purposes.

### SUMMARY OF THE INVENTION

The present invention provides a water-based bonding adhesive for bonding PVC and KEE using a novel combination of two water-based latexes, and a polyurethane dispersion (PUD) and optional additives.

As understood herein, “latex” refers to a composition of polymer particles in water. In preferred embodiments, the present formulation comprises two different water-based acrylic latexes. These two water-based latexes were each synthesized using acrylic monomers including ethylene, vinyl acetate, ethyl acetate and butyl acrylate. These acrylic latexes are available in different grades from different companies. In accordance with the present invention, a wide variety of latexes and PUDs were screened along with additives and fillers to develop the present formulation.

In preferred embodiments, the first latex consists of a preferred combination of: (a) vinyl acetate, (b) ethylene, and (c) butyl acrylate or ethyl acrylate monomers. This first latex had a glass transition temperature between −25 to −45 C. In addition, this first latex had very high polymer solids ranging between 55-70 wt %. Preferably, the pH of the first latex is acidic in nature.

In preferred embodiments, the second latex consists of a preferred combination of: (a) vinyl acetate and (b) ethylene monomers. The glass transition temperature of the second latex was between −10 C to 5 C. In addition, the second latex has very high polymer solids ranging between 60-70 wt %. Preferably, the pH of the second latex is acidic in nature as well.

In preferred embodiments, a Polyurethane dispersion (PUD) is added. The polymer used in this PUD preferably consists of polyether polyol, aliphatic isocyanates and diamines. Polymer solids in PUD were between 15-35 wt %. Preferably, the pH of the PUD should be basic.

In experiments conducted by the present inventors, preferred formulations of the first and second latexes and PUC were shown to be efficient in bonding both PVC and KEE membranes. In addition, experimental testing showed that an adhesive that was prepared using only the first latex showed reduction in adhesion performance over time. Experimental testing also showed that an adhesive that was prepared using only the second latex did not have contact adhesive properties due to lack of tackiness of the latex.

In accordance with the present invention, therefore, these limitations were overcome by harnessing the properties of the first and second latexes together. The combination of these two latexes at specific concentrations set forth below yielded optimized formulation with enhanced adhesion performance while maintaining high coverage area per gallon. The assembly was prepared using cellulose based substrate, water-based adhesive and Carlisle Construction Material PVC membrane.

In preferred embodiments, the PUD was added in the formulation to impart adhesion to KEE membranes.

The four important factors which make these two latexes and PUD perform was their monomer composition, glass transition temperature, compatibility with each other in the formulation and polymer solids in each latex. These four important factors contributed to the optimum performance and formulation stability, providing an ideal water-based adhesive for both PVC and KEE membranes.

It was experimentally determined that the adhesive formulation described below can be used as contact adhesive for a very high coverage area per gallon (which is generally not the case for such adhesives). For example, the adhesion values for the formulation were experimentally determined to be greater than 2 lbf/in along with coverage rates more than 150 SQF/gal.

TABLE 1
Preferred Formulations of the Present Adhesive:

| | Weight % |
|---|---|
| Ingredients | Range |
| Latex 1 | 10-90 |
| Latex 2 | 90-10 |
| PUD | 15-35 |
| Defoamer | 1-2 |
| Biocide | 1-2 |
| Surfactant | 0.5-2 |
| Rheology | 1-2 |
| Modifier | |

In preferred embodiments, the first latex was 10-90 wt % of the formulation. In specific preferred embodiments, the range was between 25-45 wt %.

In preferred embodiments, the second latex was 10-90 wt % of the formulation. In specific preferred embodiments, the range was between 25-45 wt %.

In preferred embodiments, the PUD was 10-40 wt % of the formulation. In specific preferred embodiments, the range was between 15-35%.

Optional additives that can also be added include a defoamer, a biocide, and a rheology modifier which were used at 1-2 wt % of the total formulation.

The surfactant used in the formulation between 0.5-2 wt % of the total formulation to lower the surface tension of the formulation below 30 dynes/cm.

Successfully mixing these components at the preferred ranges stated herein resulted in an adhesive having peel adhesion values greater than 2 lbf/in at a 150 SQF coverage rate.

In preferred embodiments, the first latex is Vinnapas EAF 68 and the second latex is Vinnapas EP 700. Also in preferred embodiments, the polyurethane dispersion (PUD) is NeoReZ R 600, the defoamer is Foamaster 111, the biocide is Mergal 186, the surfactant is Rheobyk 3451 and the rheology modifier is Rheobyk 7600.

What is claimed is:

1. A water-based adhesive for PVC and KEE roofing membranes, comprising:
a first latex, comprising:
(a) vinyl acetate,
(b) ethylene, and
(c) butyl acrylate or ethyl acrylate monomers, wherein the first latex has a glass transition temperature between −25 to −45 C;
a second latex, comprising:
(a) vinyl acetate, and
(b) ethylene monomers, wherein the second latex has a glass transition temperature between −10 C to 5 C; and
a polyurethane dispersion (PUD).

2. The water-based adhesive of claim 1, wherein the first latex comprises 10-90 wt % of the formulation.

3. The water-based adhesive of claim 2, wherein the first latex comprises 25-45 wt % of the formulation.

4. The water-based adhesive of claim 1, wherein the second latex comprises 10-90 wt % of the formulation.

5. The water-based adhesive of claim 4, wherein the second latex comprises 25-45 wt % of the formulation.

6. The water-based adhesive of claim 1, wherein the PUD comprises 10-45 wt % of the formulation.

7. The water-based adhesive of claim 4, wherein the PUD comprises 15-25 wt % of the formulation.

8. The water-based adhesive of claim 1, wherein:
the first latex has polymer solids ranging between 55-70 wt %, and
the second latex has polymer solids ranging between 60-70 wt %.

9. The water-based adhesive of claim 1, further comprising any of a defoamer, a biocide, and a rheology modifier at 1-2 wt % of the total formulation.
